(19) United States
(12) Patent Application Publication
(10) Pub. No.: US 2011/0256319 A1
(43) Pub. Date: Oct. 20, 2011

(54) AQUEOUS COATING SUBSTANCE, METHOD FOR THE PRODUCTION THEREOF, AND USE THEREOF

(75) Inventor: Bernhard Steinmetz, Rutschenhausen (DE)

(73) Assignee: BASF COATINGS GMBH, Munster (DE)

(21) Appl. No.: 13/140,977

(22) PCT Filed: Dec. 17, 2009
(86) PCT No.: PCT/EP09/09065

§ 371 Date: Jun. 20, 2011

(30) Foreign Application Priority Data
Dec. 20, 2008 (DE) 102008064254.1

(51) Int. Cl. C09D 175/04; B05D 3/00; C08K 5/1515

(52) U.S. Cl. 427/385.5; 524/114

(57) ABSTRACT

The present invention relates to an aqueous coating material comprising at least one stabilized, saturated or unsaturated polyurethane and at least one alkoxylated monoalcohol, to a process for preparing the coating material, and to its use.

### FIELD OF THE INVENTION

The present invention relates to a new aqueous coating material comprising a stabilized, saturated or unsaturated polyurethane and at least one alkoxylated monoalcohol.

The present invention further relates to a new process for preparing the aqueous coating material. The present invention additionally relates to the use of the new coating material, and also to the use of alkoxylated monoalcohols in polyurethane-containing coating materials for increasing the pinholing limit and/or reducing the pinhole count.

Aqueous coating materials comprising at least one saturated or unsaturated and stabilized polyurethane are known. They may be cured physically, thermally, or both thermally and with actinic radiation. Preferably they comprise color and/or effect pigments and are used for producing color and/or effect paint systems, especially basecoats as part of multicoat paint systems or solid-color topcoat systems.

In the course of the coating of automobile bodies there are a very wide variety of application defects that may occur. One frequent defect pattern is the appearance of pinholes, which are visible as very small holes in the clearcoat and basecoat. In the past there have been many attempts to counter this problem.

### PRIOR ART

DE 10 2005 060 302 A1 attempted to raise the pinholing limit and/or reduce the pinhole count by making the coating material comprise, in addition to a polyurethane, a wetting or dispersing agent and an organic solvent as well.

EP 1 054 930 B1 discloses a multicomponent coating where the basecoat comprises a crosslinkable, film-forming resin and an alcohol having at least 7 successive C atoms in the alkyl moiety, but without alkoxy-based radicals. One of the qualities of a metallic version of the coating is good pinhole resistance.

WO 2007-048587 A1 attempted to reduce clouding with a composition comprising a polyurethane, a pigment, and a phosphoric ester.

In JP 2002-126618 the intention in particular is to improve impact resistance and stone-chip resistance of multicoat polyester-based coating systems. Among others, preferably polyoxyalkylenated ethers are used as dispersants.

JP 2007-039616 describes a metallic coating with outstanding flip-flop properties, comprising a binder, a curing agent, and a photoluminescent pigment. Preferred dispersants specified include polyoxyethylene stearyl or oleyl ethers.

EP 1 412 436 B1 discloses a clearcoat slurry which besides dimensionally stable particles and a wetting agent also contains alkoxylated fatty alcohols having 16-18 C atoms in the alkyl radical and on average at least 20 oxaalkanediyl groups. The intention with such compositions is to avoid pops and cracking.

U.S. Pat. No. 7,358,294 B2 describes crosslinkable polyurethanes which carry hydrophilic groups. Polyethylene oxide groups with preferably more than 15 ethylene oxide units are specified. The compositions exhibit improved drying properties.

Furthermore, WO 1998/003243 describes mixedly ethoxylated and propoxylated glycerol or polyglycerol adducts with a short-chain alcohol moiety. WO 1996/023568 describes ethoxylated triglycerides having an ethylene oxide content of 40-80% by weight. The products described in the two last-mentioned specifications are used as defoamers.

All of the approaches referred to above have been available so far to provide a satisfactory solution to the pinholing problems.

### PROBLEM AND SOLUTION OF THE INVENTION

One phenomenon present in the coating operation is the occurrence of pinholes. These very small holes in the coating make the body or defect site liable for repair, and hence are a cause of extra work, which ought to be avoided.

Despite previous approaches at a solution to this problem, it has not yet been possible satisfactorily to solve the pinholing problems.

Consequently the problem addressed by the present invention is that of providing a new aqueous coating material which exhibits very few pinholes, or none, and/or has an increased pinholing limit.

The pinholing limit is the lowest dry film thickness of the basecoat film at which pinholes occur.

The new aqueous coating material ought to be suitable in particular as a water-based basecoat for producing color and/or effect basecoats of multicoat paint systems by the wet-on-wet method.

The new aqueous coating material ought to provide coatings, preferably color and/or effect coatings, more preferably basecoats and solid-color topcoats, especially basecoats in multicoat paint systems, which are very largely free of pinholes.

Surprisingly it has been found that an aqueous coating material comprising (a) an ionically or nonionically stabilized, saturated or unsaturated polyurethane, (b) at least one wetting and/or dispersing agent, and (c) at least one alkoxylated monoalcohol of the following formula

R-[AO]ₙ—H,

wherein the alkoxylated monoalcohol is present in an amount of 0.1 to 5% by weight, based on the weight of the coating material, the radical R being an alkyl radical having 8 to 20 C atoms, the index n being an integer from 1 to 5, and the radical [AO] representing an alkylene oxide radical solves the problem identified above.

In particular it is surprising that the coating material of the invention is easy to prepare and that, in comparison with noninventive coating systems, the coating systems obtained exhibit no pinholes, or exhibit pinholes only at high film thicknesses.

The aqueous coating material of the invention is therefore suitable as a water-based basecoat for producing color and/or effect basecoats of multicoat paint systems by the wet-on-wet method.

The new aqueous coating material is used, accordingly, in coatings, preferably in color and/or effect coatings, more preferably in basecoats and solid-color topcoats, and with particular preference in basecoats of multicoat paint systems.

The preferred substrates in these contexts are automobile bodies or parts thereof.

Also found has been a new process for preparing the aqueous coating material of the invention. This process comprises mixing with one another (a) at least one saturated or unsaturated, ionically or nonionically stabilized polyurethane, (b) at least one wetting or dispersing agent, and (c) at least 0.1 to 5% by weight of an alkoxylated monoalcohol, based on the total weight of the coating material, the alkoxylated monoalcohol possessing the formula R-[AO]ₙ—H, the radical R being an alkyl radical having 8 to 20 C atoms, the index n being an integer from 1 to 5, and the radical [AO] representing an alkylene oxide radical.

Found not least has been the new use of the coating material of the invention and of the coating material prepared by the process of the invention for producing multicoat color and/or effect paint systems.

If the coating material of the invention additionally comprises pigments and/or fillers, and especially color and/or effect pigments, then it produces coatings of the invention which exhibit a particularly high hiding power (in accordance with DIN EN ISO 28199-3) and an outstanding overall appearance. The coating material of the invention is therefore outstandingly suitable for the coating of automobile bodies.

The coating material of the invention is an aqueous coating material. “Aqueous” in this context means that there are 30 to 70% by weight of water, based on the overall coating material.

### DETAILED DESCRIPTION OF THE INVENTION

The first essential constituent of the coating material of the invention is a saturated or unsaturated polyurethane. Suitable polyurethanes are known, for example, from
German patent application DE 199 11 498 A1, column 1, lines 29 to 49, and column 4, line 23, to column 11, line 5,
German patent application DE 199 48 004 A1, page 4, line 19, to page 13, line 48,
European patent application EP 0 228 003 A1, page 3, line 24, to page 5, line 40,
European patent application EP 0 634 431 A1, page 3, line 38, to page 8, line 9, or
international patent application WO 92/15405, page 2, line 35, to page 10, line 32.

To stabilize it the polyurethane preferably contains either
functional groups which can be converted by neutralizing agents and/or quaternizing agents into cations, and/or cationic groups,
   or
functional groups which can be converted by neutralizing agents into anions, and/or anionic groups, and/or
nonionic hydrophilic groups.

The polyurethane is linear or contains branches. The polyurethane may also take the form of a graft polymer. In that case the polyurethane is grafted preferably with acrylate groups. The corresponding acrylate groups are introduced into the polymer after preparation of a polyurethane primary dispersion.

Such graft polymers are known to the skilled worker and are described, for example, in DE 199 48 004 A1.

Where the coating material of the invention is curable physically, thermally with self-crosslinking, or thermally with self-crosslinking and with actinic radiation, its polyurethane content is preferably 50% to 100%, more preferably 50% to 90%, and in particular 50% to 80%, by weight, based in each case on the film-forming solids of the coating material of the invention.

By film-forming solids is meant the nonvolatile mass fraction of the coating material without pigments and/or fillers.

If the coating material of the invention is curable thermally with external crosslinking, or thermally with external crosslinking and with actinic radiation, its polyurethane content is preferably 10% to 80%, more preferably 15% to 75%, and in particular 20% to 70%, by weight, based in each case on the film-forming solids of the coating material of the invention.

A further constituent used that is essential to the invention are alkoxylated monoalcohols of the formula

R-[AO]ₙ—H.

The alkoxylated monoalcohol is present in the coating material in an amount of 0.1% to 5% by weight, based on the total weight of said material. The radical R is an alkyl radical. The alkyl radical R may be linear or contain branches. The index n describes an integer from 1 to 5, and the radical [AO] represents an alkylene oxide radical.

The alkyl chain R may be branched or unbranched and contains at least 8 C atoms, preferably at least 10 C atoms, and more preferably at least 12 C atoms.

If the radical R contains a branch, the branch preferably comprises structures of the kind described, for example, in A. J. O'Lenick jr.: “A Review of Guerbet Chemistry”.

If the radical R contains a branch, the radical R likewise comprises at least 8 C atoms.

The number of alkylene oxide radicals [AO] joined directly to one another in the formula R-[AO]ₙ—H is characterized by the index n. The index n is an integer and varies from 1 to 5. Preferably n is 1 to 3 and more preferably n is 1 or 2.

A single alkylene oxide unit [AO] possesses preferably 1 to 4 C atoms and more preferably 1 to 3 C atoms.

The term “alkylene oxide radical” refers to those units which possess an alkylene chain attached to an oxygen atom. An example is the group CH₂—CH₂—O. In the formula R-[AO]ₙ—H, therefore, the oxygen atom is always bonded directly to the terminal H atom.

The alkoxylated monoalcohols are customary and known, commercially available products. For example, such alkoxylated monoalcohols are sold under the brand names Lutensol®, Degressal®, Pluriol®, Dehydol®, Disponil® or Dehypon®.

The amount of the alkoxylated monoalcohols may vary and may thus be tailored optimally to the requirements of the case in hand. In this context it may be emphasized that an alkoxylated monoalcohol content of 0.1% to 5%, preferably 0.1% to 4%, and in particular 0.2% to 3%, by weight, based in each case on the coating material of the invention, is sufficient to achieve the advantageous technical effects of the invention. Where the content is more than 5% by weight based on the coating material of the invention, it may be necessary in certain circumstances to accept disadvantages, such as an impairment in adhesion in the case of underbaked bodies, for example.

Furthermore, the coating material of the invention may further comprise at least one additive. Preferably it comprises at least two additives. The additive is preferably selected from the group of additives that are typically used in the field of coating materials. Particular preference is given to selecting the additive from the group consisting of salts which can be decomposed thermally without residue or substantially without residue, non-polyurethane binders that are curable physically, thermally and/or with actinic radiation, crosslinking agents, organic solvents, thermally curable reactive diluents, reactive diluents curable with actinic radiation, color and/or effect pigments, transparent pigments, fillers, molecularly dispersely soluble dyes, nanoparticles, light stabilizers, antioxidants, deaerating agents, emulsifiers, slip additives, polymerization inhibitors, free-radical polymerization initiators, thermolabile free-radical initiators; adhesion promoters, flow control agents, film-forming assistants, such as thickeners and structurally viscous sag control agents (SCA), flame retardants, corrosion inhibitors, free-flow aids, waxes, siccatives, biocides, and matting agents.

Suitable additives of the aforementioned kind are known, for example, from
German patent application DE 199 48 004 A1, page 14, line 4, to page 17, line 5,
German patent DE 100 43 405 C1, column 5, paragraphs [0031] to [0033].

They are used in the customary and known amounts.

The solids content of the coating material of the invention may vary and may therefore be tailored optimally to the requirements of the case in hand. First and foremost the solids content is guided by the viscosity which is needed for application, especially spray application, and so can be adjusted by the skilled worker on the basis of his or her general art knowledge, where appropriate with the aid of a few range finding tests.

The solids content of the coating material is preferably 5% to 70%, more preferably 10% to 65%, and with particular preference 15% to 60% by weight.

By solids content is meant that that mass fraction which remains as a residue on evaporation under fixed conditions. In the present application the solids was determined in accordance with DIN EN ISO 3251. The measuring time was 60 minutes at 125° C.

The coating material of the invention is prepared preferably by means of the process of the invention. The process comprises dispersing polyurethane resin, a wetting or dispersing agent, and alcohol component in an aqueous medium, more particularly in water, and then homogenizing the resulting mixture. In terms of its method the process of the invention has no peculiar features, but can instead be carried out by means of the customary and known mixing methods and mixing assemblies, such as stirred tanks, dissolvers, stirrer mills, kneaders (compounders), static mixers or extruders.

Particular preference is given to using the coating materials of the invention as solid-color topcoats for producing single-coat solid-color topcoats, or as water-based basecoats for producing multicoat color and/or effect paint systems. With very particular preference they are used as water-based basecoats for producing color and/or effect basecoats of multicoat paint systems, preferably multicoat paint systems for automobile bodies. In this context they are outstandingly suitable for OEM finishing and for refinish.

With very particular preference the multicoat paint systems of the invention are produced by wet-on-wet methods, wherein
(1) at least one water-based basecoat is applied to a primed or unprimed substrate to give at least one water-based basecoat film (1),
(2) at least one clearcoat is applied to the water-based basecoat film (1) to give at least one clearcoat film (2), and
(3) at least the water-based basecoat film(s) (1) and the clearcoat film(s) (2) are jointly cured to give the basecoat (1) and the clearcoat (2).

Examples of wet-on-wet methods of this kind are known from
German patent application DE 199 48 004 A1, page 17, line 37, to page 19, line 22, or
German patent DE 100 43 405 C1, column 3, paragraph [0018], and column 8, paragraph [0052], to column 9, paragraph [0057], in conjunction with column 6, paragraph [0039], to column 8, paragraph [0050].

The coating material of the invention is curable physically, thermally, or both thermally and with actinic radiation. The curing that takes place thermally, or both thermally and with actinic radiation, may be assisted by physical curing.

In the context of the present invention the term “physical curing” denotes the formation of a film through loss of solvent from polymer solutions or dispersions. Typically known crosslinkings are needed for this purpose. Where appropriate, the physical curing may be assisted by atmospheric oxygen or by exposure to actinic radiation.

In the context of the present invention the term “thermal curing” denotes the heat-initiated curing of a film of a coating material for which, typically, a separate crosslinking agent is employed. The crosslinking agent comprises reactive functional groups which are complementary to the reactive functional groups present in the polyurethanes. This is typically referred to by those in the art as external crosslinking. Where the complementary reactive functional groups or autoreactive functional groups, i.e., groups which react “with themselves”, are already present in the polyurethanes, the latter are self-crosslinking. Examples of suitable complementary reactive functional groups and autoreactive functional groups are known from German patent application DE 199 30 665 A1, page 7, line 28, to page 9, line 24.

In the context of the present invention, actinic radiation means electromagnetic radiation such as near infrared (NIR), visible light, UV radiation, X-rays or γ radiation, especially UV radiation, and particular radiation such as electron beams, beta radiation, alpha radiation, proton beams or neutron beams, especially electron beams. Curing by UV radiation is typically initiated by free-radical or cationic photoinitiators.

Where thermal curing the curing with actinic light are employed jointly in respect of a coating material of the invention, the term “dual cure” is also used.

The coating material of the invention may be a one-component (1K) system.

In the context of the present invention a one-component (1K) system may be a thermosetting coating material, in which the binder and the crosslinking agent are present alongside one another, i.e., in one component. A prerequisite for this is that the two constituents crosslink with one another only at relatively high temperatures and/or on exposure to actinic radiation.

The coating material of the invention may additionally be a two-component (2K) or multicomponent (3K, 4K) system.

In the context of the present invention this means a coating material in which, in particular, the binder and the crosslinking agent are present separately from one another in at least two components, which are not combined until shortly before application. This form is chosen when binder and crosslinking agent react with one another even at room temperature. Coating materials of this kind are employed primarily in the coating of thermally sensitive substrates, especially in automotive refinish.

The present invention further provides for the use of the coating materials of the invention as water-based basecoats for producing multicoat color and/or effect paint systems, particularly those by the wet-on-wet method. Particularly suitable substrates are metallic substrates. Preferred examples of substrates are automobile bodies or parts thereof.

The invention also provides for the use of the alkoxylated monoalcohols used in the coating material of the invention, in polyurethane-containing coating materials, for the purpose of increasing the pinholing limit and/or reducing the pinhole count by comparison with identical polyurethane-containing coating materials but to which such alkoxylated monoalcohols have not been added. Also in accordance with the invention is the use of the alkoxylated monoalcohol as used in the coating materials of the invention in pigmented polyurethane-containing coating materials for the purpose of increasing the hiding power by comparison with the same polyurethane-containing coating materials prepared without the corresponding alkoxylated monoalcohol.

The examples which follow illustrate the invention.

### EXAMPLES

### Preparation of a Gray Water-based Basecoat 1

For better assessment of any paint defects occurring, a gray water-based basecoat was used, which was prepared in accordance with the following instructions.

### Mixture of 1a:

In a dissolver, 26 parts by weight of a dispersion of an inorganic thickener (sodium magnesium phyllosilicate, 3% by weight in water) were introduced. Added thereto were 30 parts by weight of deionized water, 107.5 parts by weight of butyl glycol, 4.5 parts by weight of a polyurethane-modified polyacrylate prepared as per page 7, line 55 to page 8, line 23 of German patent application DE 44 37 535 A1, and 0.6 part by weight of a 20.5% strength by weight solution of a commercial defoamer (Nopco® DSX 1550 from Cognis), with stirring. This gave the mixture 1a.

### Mixture of 1b:

Separately from this, 3.2 parts by weight of an aqueous polyester resin dispersion prepared as per example D., column 16, lines 37 to 59, of German patent application DE 40 09 858 A1, 0.3 part by weight of a surfactant solution containing 52% by weight of Surfynol® 104 from Air Products, 55 parts by weight of butyl glycol, 4.1 parts by weight of a commerical, water-thinnable melamine-formaldehyde resin in n-butanol (Cymel® 203 from Surface Specialties Austria), and 0.3 part by weight of a 10% strength by weight solution of dimethylethanolamine in water were mixed with one another. This gave the mixture 1b.

### Mixture of 1c:

Mixtures 1a and 1b were mixed with one another. The result was the mixture 1c.

### Mixture of 1d:

Mixture 1c was admixed with 6 parts by weight of deionized water, 20.4 parts by weight of an acrylated polyurethane prepared as per page 19, line 44 to page 20, line 7 of German patent application DE 199 48 004 A1, 1.6 parts by weight of a surfactant solution containing 52% by weight of Surfynol® 104 from Air Products, 48 parts by weight of butoxyethanol, 0.4 part by weight of a 10% strength by weight solution of dimethylethanolamine in water, 1.6 parts by weight of n-butanol, and 3.9 parts by weight of a 3% strength by weight solution of a polyacrylate thickener (Viscalex® from Ciba). The result was the mixture 1d.

### Carbon Black Paste:

The carbon black paste was prepared from 25 parts by weight of a polyacrylate dispersion prepared as per international patent application WO 91/15528 (page 23, line 29 to page 24, line 24), 10 parts by weight of carbon black, 0.1 part by weight of methyl isobutyl ketone, 1.36 parts by weight of dimethylethanolamine, 2 parts by weight of a commercial polyether (Pluriol® P900 from BASF Aktiengesellschaft), and 61.45 parts by weight of deionized water, by mixing.

### Blue Paste:

The blue paste was prepared from 19.4 parts by weight of a polyurethane dispersion prepared as per column 16, lines 10 to 35 of German patent application DE 40 09 858 A1, 13.5 parts by weight of Paliogen® Blau L 6482 from BASF AG, 4.3 parts by weight of butoxyethanol, 0.18 part by weight of methyl ethyl ketone, 0.62 part by weight of dimethylethanolamine, 1.2 parts by weight of Pluriol® P900 from BASF Aktiengesellschaft, and 61 parts by weight of water, by mixing.

### Paste Mixture:

The paste mixture was prepared from 0.5 part by weight of the carbon black paste, 0.1 part by weight of the blue paste, and 0.5 part by weight of a paste prepared as per number 9 of German patent application DE 100 04 494 A1.

### Mixture of 1e:

Mixture 1e was prepared by mixing all of the resulting paste mixture and all of the resulting mixture 1d.

### Aluminum Effect Pigment Paste:

The aluminum effect pigment paste was prepared from 3.2 parts by weight of a first 65% by weight pasted aluminum effect pigment (Alu-Stapa-Hydrolux® 2153 from Eckart) and 3.2 parts by weight of a second 65% by weight pasted aluminum effect pigment (Alu-Starter-Hydrolux 8154 from Eckert), 7.5 parts by weight of butyl glycol, and 5.0 parts by weight of the aqueous polyester resin dispersion prepared as per example D., column 16, lines 37 to 59, of German patent application DE 40 09 858 A1.

### Water-based Basecoat Material 1:

The water-based basecoat material 1 was prepared by mixing all of the resulting mixture 1 e, all of the resulting aluminum effect pigment paste, and two parts by weight of water. It was then adjusted with dimethylethanolamine to a pH of 8 and with deionized water to a viscosity of 58 mPas under a shear loading of 1000/second as measured with a rotational viscometer (Rheomat RM 180 from Mettler-Toledo) at 23° C.

Water-based basecoat material E2:

The inventive water-based basecoat material E2 was prepared by admixing water-based basecoat material 1 with 1.5 parts by weight of commercially available Lutensol® AO3.

### Water-based Basecoat Material E3:

The inventive water-based basecoat material E3 was prepared by admixing water-based basecoat material 1 with 1.5 parts by weight of commercially available Lutensol® XL40.

### Water-based Basecoat Material E4:

The inventive water-based basecoat material E4 was prepared by admixing water-based basecoat material 1 with 1.5 parts by weight of commercially available Lutensol® XP30.

### Water-based Basecoat Material E5:

The inventive water-based basecoat material E5 was prepared by admixing water-based basecoat material 1 with 1.5 parts by weight of commercially available Lutensol® XP40.

### Water-based Basecoat Material E6:

The inventive water-based basecoat material E6 was prepared by admixing water-based basecoat material 1 with 1.5 parts by weight of commercially available Dehydol® LS2.

### Water-based Basecoat Material E7:

The inventive water-based basecoat material E7 was prepared by admixing water-based basecoat material 1 with 1.5 parts by weight of commercially available Dehydol® LT2.

### Water-based Basecoat Material E8:

The inventive water-based basecoat material E8 was prepared by admixing water-based basecoat material 1 with 1.5 parts by weight of commercially available Dehydol® LS3DEO N.

### Water-based Basecoat Material E9:

The inventive water-based basecoat material E9 was prepared by admixing water-based basecoat material 1 with 1.5 parts by weight of commercially available Dehypon® OCP502.

### Water-based Basecoat Material E10 (Comparative):

The noninventive water-based basecoat material E10 was prepared by admixing water-based basecoat material 1 with 1.5 parts by weight of commercially available Agitan® 281 (defoamer).

### Water-based Basecoat Material E11 (Comparative):

The inventive water-based basecoat material E11 was prepared by admixing water-based basecoat material 1 with 1.5 parts by weight of commercially available 1-octanol.

TABLE 1
Compositions of the water-based basecoat materials (WBB)
1 and E2-E11

| WBB | [% by weight] | Alkoxylated monoalcohol |
|---|---|---|
| 1 | — | — |
| E2 | 1.5 | Lutensol ® AO3 |
| E3 | 1.5 | Lutensol ® XL40 |
| E4 | 1.5 | Lutensol ® XP30 |
| E5 | 1.5 | Lutensol ® XP40 |
| E6 | 1.5 | Dehydol ® LS2 |
| E7 | 1.5 | Dehydol ® LT2 |
| E8 | 1.5 | Dehydol ® LS3DEO N |
| E9 | 1.5 | Dehypon ® OCP502 |
| E10 (comparative) | 1.5 | Agitan ® 281 |
| E11 (comparative) | 1.5 | 1-Octanol |

The weight percentages in table 1 relate to the fraction of the alkoxylated monoalcohol in the respective water-based basecoat material.

### Comparative Test Between Water-based Basecoat Material 1 and Water-based Basecoat Materials E2 to E11

For the purpose of determining the pinholing limit and the pinhole count, the multicoat paint systems were produced by the following general instructions:

A steel panel measuring 30×50 cm, coated with a primer-surfacer, was provided on one long edge with an adhesive strip, in order to allow the differences in film thickness to be determined after coating. The water-based basecoat material was applied electrostatically in the form of a wedge. The resulting water-based basecoat film was flashed off at room temperature for a minute and then dried in a forced-air oven at 70° C. for 10 minutes. Over the dried water-based basecoat film a typical two-component clearcoat material was applied. The resulting clearcoat film was flashed off at room temperature for 20 minutes. Subsequently the water-based basecoat film and the clearcoat film were cured in a forced-air oven at 140° C. for 20 minutes. Following visual evaluation of the pinholes in the resulting wedge-shaped multicoat paint system, the film thickness of the pinholing limit was ascertained. The results are found in table 2.

TABLE 2
Pinholing limit and pinhole count of water-based
basecoat material 1 and
of water-based basecoat materials E2 to E11

| | Pinholing limit | |
|---|---|---|
| WBB | (μm) | Pinhole count |
| 1 | 12 | 47 |
| E2 | 26 | 14 |
| E3 | 26 | 72 |
| E4 | 26 | 64 |
| E5 | 26 | 81 |
| E6 | 25 | 19 |
| E7 | 34 | 32 |
| E8 | 26 | 73 |
| E9 | 28 | 59 |
| E10 (comparative) | 17 | 50 |
| E11 (comparative) | 22 | 42 |

The results underline the fact that the use of inventively alkoxylated monoalcohols significantly increases the pinholing limit in comparison to water-based basecoat material 1, highly alkoxylated defoamer (E10), and unalkoxylated monoalcohol (E11; 1-octanol), and in some cases at the same time significantly reduces the pinhole count.

1. An aqueous coating material comprising (a) at least one polyurethane that is stabilized either ionically or nonionically, (b) at least one wetting and/or dispersing agent, and (c) at least one alkoxylated monoalcohol of the following formula
R-[AO]ₙ—H
wherein the alkoxylated monoalcohol is present in an amount of 0.1 to 5% by weight, based on the weight of the coating material, the radical R being an alkyl radical having 8 to 20 C atoms, the index n being an integer from 1 to 5, and the radical [AO] representing an alkylene oxide radical.

2. The coating material of claim 1, wherein the radical R is linear.

3. The coating material of claim 1, wherein the radical R has a branch.

4. The coating material of claim 1, wherein the index n is an integer from 1 to 3.

5. The coating material of claim 1, wherein the alkylene oxide radical [AO] comprises 1 to 4 carbon atoms.

6. The coating material of claim 1, wherein the polyurethane is linear or branched.

7. The coating material of claim 1, wherein the polyurethane is grafted.

8. The coating material of claim 1, wherein one or more of a pigment, a filler or the combination thereof, is present in an amount of up to 40% by weight, based on the total weight of the coating material.

9. A process for preparing the aqueous coating material of claim 1, which comprises mixing with one another (a) at least one polyurethane that is stabilized either ionically or nonionically, (b) at least one wetting and/or dispersing agent, and (c) at least 0.1 to 5% by weight of an alkoxylated monoalcohol, based on the total weight of the coating material.

10. A method of making a multicoat color and/or effect paint system, the method comprising applying the aqueous coating material of claim 1 to a substrate, wherein the aqueous coating material is used as a water-based basecoat.

11. The method of claim 10 wherein the wet-on-wet method is used to make the multicoat color and/or effect paint system.

12. The method of claim 10, wherein the substrates is a part of an automobile body.

13. A method of increasing a pinholing limit and/or reducing a pinhole count, comprising adding an alkoxylated monoalcohol of the formula R-[AO]ₙ—H to a polyurethane-containing coating material in an amount of 0.1 to 5% by weight, based on the weight of the coating material, wherein the radical R is an alkyl radical having 8 to 20 C atoms, the index n is an integer from 1 to 5, and the radical [AO] is an alkylene oxide radical and the method of increasing a pinholing limit and/or reducing a pinhole count is in comparison with a polyurethane-containing coating material without the alkoxylated monoalcohol of the formula R-[AO]ₙ—H as defined above.

14. A method of increasing hiding power of a coating material, comprising adding an alkoxylated monoalcohol of the formula R-[AO]n-H to a pigmented polyurethane-containing coating material in an amount of 0.1 to 5% by weight based on the weight of the pigmented polyurethane-containing coating material, wherein the radical R is an alkyl radical having 8 to 20 C atoms, the index n is an integer from 1 to 5, and the radical [AO] is an alkylene oxide radical and the method of increasing hiding power is in comparison with a pigmented polyurethane-containing coating material without the alkoxylated monoalcohol of the formula R-[AO]ₙ—H as defined above.

15. The aqueous coating material of claim 1 wherein the polyurethane (a) may be saturated or unsaturated.

16. The method of claim 13 further comprising applying the polyurethane-containing aqueous coating material containing the alkoxylated monoalcohol to a substrate and curing the same.
